(19) United States
(12) Patent Application Publication
(10) Pub. No.: US 2008/0064365 A1
(43) Pub. Date: Mar. 13, 2008

(54) Safety alert system

(76) Inventors: Steve Lang, Lawrence, KS (US); Barry Siskind, Henderson, NV (US)

Correspondence Address: SHUGHART THOMSON & KILROY, PC, 120 WEST 12TH STREET, KANSAS CITY, MO, 64105, US

(21) Appl. No.: 11/891,468

(22) Filed: Aug. 11, 2007

Related U.S. Application Data
(60) Provisional application No. 60/838,536, filed on Aug. 11, 2006.

(51) Int. Cl. H04M 11/04; G08B 23/00; H04Q 7/22

(52) U.S. Cl. 455/404.1; 340/573.1; 455/414.1

(57) ABSTRACT

A safety alert system 10 is provided which allows the user to initiate a series of telephone communications by activating a pre-programmed control hub 12 by signaling the control hub 12 from a remote activation pendant 14 carried by the user to activate the control hub 12 to begin the control hub 12 dialing multiple pre-selected telephone numbers of pre-selected recipients to inform the recipients of the existence of an emergency situation involving the user, the control hub 12 also determining if the telephone communication has been answered and if the telephone communication has been answered by a person and not a mechanical device.

### CROSS REFERENCE TO RELATED APPLICATION

This application claims priority under 35 U.S.C. 119(e) and 37 C.F.R. 1.78(a)(4) based upon copending U.S. Provisional Application Ser. No. 60/838,536 for Safety Alert System filed Aug. 11, 2006 and which is incorporated herein by reference.

### FIELD OF THE INVENTION

The present invention relates to the field of emergency notification devices, in particular, health and accident and safety notification devices for use in a dwelling to allow a person to rapidly communicate with pre-selected emergency responders.

### BACKGROUND OF THE INVENTION

The number of individuals living by themselves is increasing substantially each year in the United States. The need for these individuals to have an emergency means of communication with selected relatives or the emergency services departments of their local community also increases. With the population aging, and more aging persons living by themselves, the potential for individuals living alone to become hurt or incapacitated and unable to physically reach a telephone or cell phone or to manipulate that instrument to obtain help and assistance increases.

Therefore, it would be a benefit if a device existed which permitted individuals, while hurt or incapacitated or immobilized, to initiate a series of telephone communications and which could cycle through a series of preprogrammed telephone numbers in an attempt to contact one or more emergency service providers or personal assistance providers as selected by the owner of the device.

It will be appreciated by those skilled in the art that such a device may be used in health emergencies as well as safety emergencies (police or fire) and will be most useful to those individuals who have limited physical capacities and/or who are unable to easily manipulate a standard telephone apparatus or who may be incapable of manipulating a telephone apparatus if injured or incapacitated.

### SUMMARY OF THE INVENTION

A safety alert system 10 comprised of a control base or hub 12 and one or more mobile pendants 14 is provided which allows a user to transmit a radio frequency signal from a pendant 14 to the control hub or control base 12 to active the base 12 to begin the initiation of a series of telephone communications. By activating control base or hub 12 a series of user pre-programmed telephone numbers are sequentially dialed by control hub 12. The remote activation pendant 14 carried by the user to activate the control hub 12 can be operated to active control hub 12 from a distance of approximately 100 feet.

Once activated control hub 12 begins sequentially dialing user pre-selected and pre-stored telephone numbers that reside in the memory 72 of control hub 12. The dialing of the user pre-selected and pre-stored telephone numbers serves to telephonically contact pre-determined telephone call recipients to inform the call recipients, by the playing of a prerecorded message, of the existence of an emergency situation involving the user. The control hub 12 also can determine if the telephone communication has been answered and if the telephone communication has been answered by a person and not a mechanical device. This is accomplished by the interaction between pre-recorded message played by control hub 12 and the control hub 12 expecting to receive pre-determined audio responses from the call recipient upon the cessation of ring tones. The control base or hub 12, during the playing of its pre-recorded message, requests the party answering the telephone call to press particular buttons on the call recipient's telephone. The controller 70 of control hub 12, upon receiving the expected, requested tone from the call recipient's telephone, recognizes that a human being and not a machine has responded to the pre-recorded message and therefore to the telephone call. The software operated on controller 70 of control hub 12 then determines to cease to continue to sequentially call the remaining pre-selected and pre-stored telephone numbers held in the memory 72 of control hub 12.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a front elevation view of the safety alert system 10 including control hub 12 and pendant 14;

FIG. 2 is a diagrammatic representation of the front elevation view of the control hub 12 of the safety alert system 10;

FIG. 3 is a front and bottom and right side perspective view of pendant 14; and

FIG. 4 is an exploded view of pendant 14; and

FIG. 5 is an exploded view of control hub 12.

### DESCRIPTION OF THE PREFERRED EMBODIMENT

As required, detailed embodiments of the safety alert system are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the safety alert system in virtually any appropriately detailed structure.

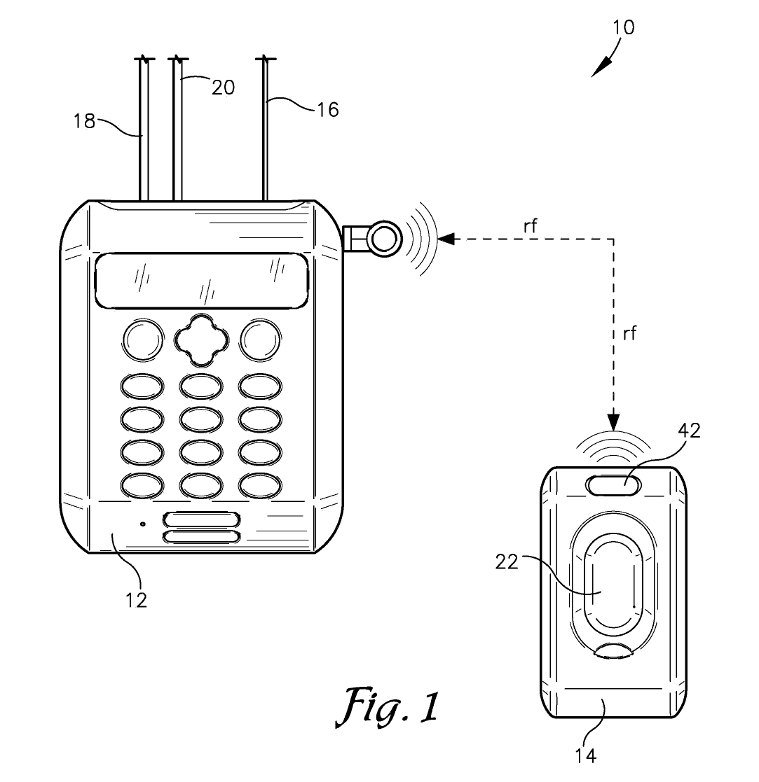

First referring to FIG. 1 the general structure of the safety alert system 10 will be discussed. The alert system 10 is comprised of a control hub 12 and one or more user pendants 14. In general, the control hub 12 is mounted in a central location of a dwelling so it may be conveniently attached to a power line 16 and to a telephone line 18 and/or other communication line 20. Pendant 14 provides a radio frequency (rf) signal to control hub 12 which receives the rf signal and activates the series of processes programmed into controller 70 and EEPROM 72 of control hub 12 upon the user pressing activation button 22 of pendant 14 in an emergency situation. It will be appreciated by those skilled in the art that, in general, upon activation of pendant 14 by the depressing of activation button 22, that a radio frequency signal is transmitted to control hub 12. Control hub 12 receives the rf signal via receiver 74 (FIG. 5) and this initiates a series of preprogrammed telephone dialing and message playback activities designed to send notification to one or more emergency locations via a telephone transmission.

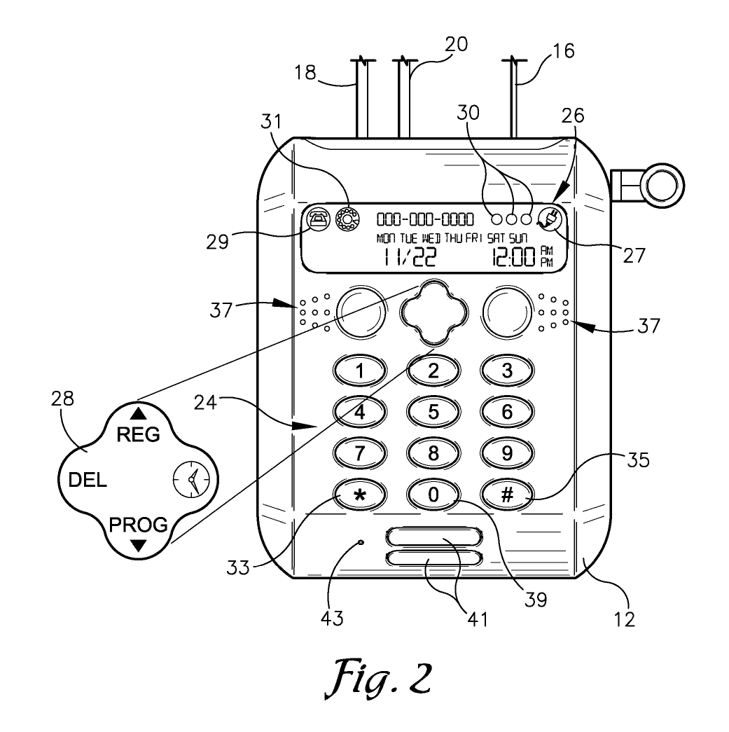

Referring now to FIG. 2, the operational aspects provided in control hub 12 will be described. Control hub 12 is approximately 3.5 inches by 4.5 inches by 1 inch in size and provides the user with keypad 24 and display 26 and four-way selector button 28 for use in programming control hub 12. The programming of control hub 12 will be described hereinafter. As previously described, control hub 12 is provided with a power supply jack 16 and telephone cable jack 18 and a second jack for communications line 20. Control hub 12 is provided with display 26 which allows the user to monitor the current state of functioning of control hub 12 as well as to monitor the current state of programming of control hub 12. In addition, display 26 allows the user to review the programming and operational status of control hub 12 at any time.

Again referring to FIG. 2, control hub 12 permits the entry into a memory, such as an electrically erasable programmable read-only memory (EEPROM) 72 (FIG. 5), of control hub 12, three sets of phone numbers each of which may be up to 14 digits in length. During the programming procedure, the particular phone number being programmed into control hub 12 is indicated by the illumination of telephone memory indicators 30. To program a telephone number into control hub 12, the user presses four-way selector 28 and selects the bottom position marked “PROG” to initiate programming of control hub 12. The “PROG” button should be held for three seconds after the tone is heard, LCD 30 on control hub 12 then will begin to flash, and the user then is to enter the phone number desired to be saved into memory. After entry of the telephone number, the user should then press on keypad 24 one of the memory positions marked as “M1, M2, or M3” to select the memory position of the number just entered into memory. The depressing and holding of buttons marked “M1, M2 or M3” will save the telephone number entered by the user into memory 72 of control hub 12. Should the user have made an error in entry of the telephone number, the user can depress the “delete” button (“DEL”) of four-way selector 28 to return to the number previously stored. If, during the programming process, the user fails to depress either of buttons “M1, M2 or M3” within ten (10) seconds of entry of telephone digits, control hub 12 will revert to standby mode and be active should an emergency signal be sent by the depressing of activation button 22 on pendant 24.

Should the user wish to review telephone numbers that have been saved into control hub 12, the user can press the buttons marked “M1, M2 or M3” while control hub 12 is in standby mode, and the telephone stored in that particular memory position will be displayed on display 26. If the user wishes to delete the telephone number stored in any of the memory positions “M1, M2 or M3,” the user first selects the memory position while control hub 12 is in the standby mode and then immediately depresses and holds the delete button on four-way selector 28 for three seconds to delete the phone number from the memory of control hub 12. The sounding of a long “beep” tone means that the memory position has been cleared.

Still referring to FIG. 2, when the user wishes to set the correct time of day on control hub 12, the user depresses the four-way selector position marked with the face of a clock on selector 28. The display position for the month will begin flashing. The user then uses the up or down arrow buttons of four-way selector 28 to change the indicated month. To move to the day of the month, the user again depresses the clock face button, or the right hand button, of four-way selector 28, and the date will begin to flash in display 26, and again the user will use the up and down arrow buttons of four-way selector 28 to change the date that is being displayed on display 26. Once the user has entered the month and day, the user presses the right hand button of four-way selector 28 having the clock face thereon for a final time to confirm the month and day date setting and to exit that function of control hub 12.

To link or make the connection between control hub 12 and pendant 14 it is necessary to register the hub 12 and the pendant 14 with one another. This function is accomplished by the user pressing the top button of a four-way selector 28 marked “REG” to be in the registration mode. After depressing the “REG” button, the user should hold the button for three seconds at which point the control hub LED will begin to flash indicating that it is ready to receive the rf signal from pendant 14 to register the pendant with control hub 12. The user then presses activation button 22 on pendant 14 and holds the button for three seconds to execute the registration of the pendant 14 with control hub 12. When registration has been successfully completed, control hub 12 will “beep” two times to confirm the registration of pendant 14 with control hub 12. Control hub 12 is further provided with an AC power detector icon 27 which is shown in FIG. 2 in the form of an electrical plug in a circle. This indicator light will show the presence of a low battery condition in control hub 12 and remind the user to connect the control hub to power supply. It will be appreciated that control hub 12 is intended to operate off line voltage available in the building but that battery power supply is included within control hub 12 to allow the invention to remain operational during power outages.

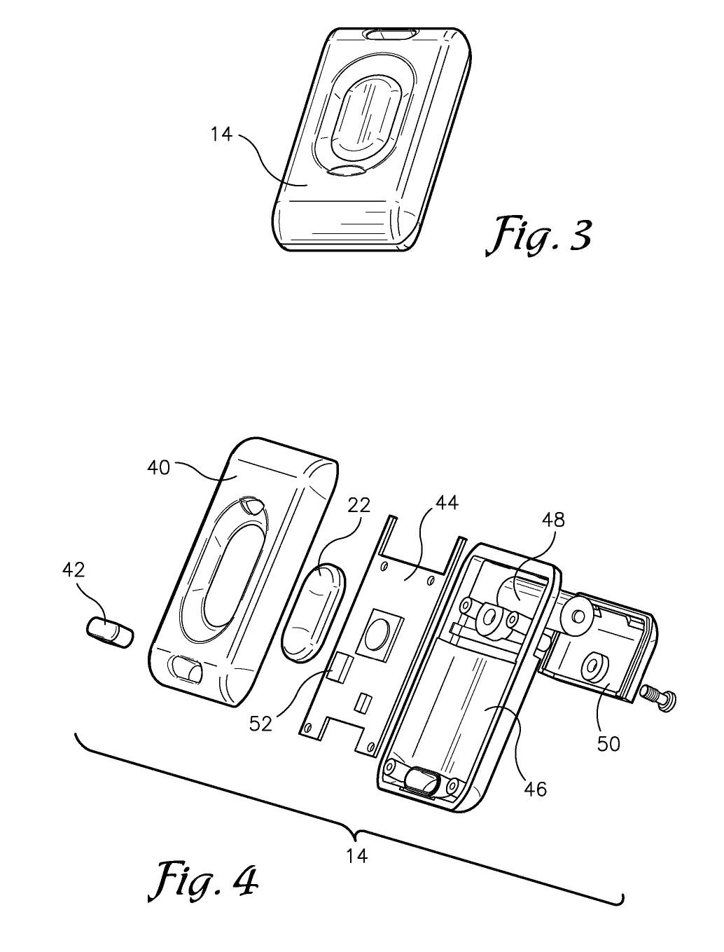

Control hub 12 also detects the proper connection of a telephone line into the telephone line in jack 18 of control hub 12. If no telephone line is detected, the telephone icon 29 shown in FIG. 2 will illuminate to remind the user to plug the telephone line into control hub 12. Control hub 12 also will detect whether or not emergency telephone numbers have been entered into the system. If no emergency number has been saved in control hub 12, the icon 31 shown in FIG. 3 representing the dial of a telephone will remind the user to enter an emergency telephone number into control hub memory. When the safety alert system is activated to begin calling the pre-stored telephone numbers, LED's light up behind window 41 below the number pad when the alarm is activated.

An integral part of the safety alert system is the provision of an outgoing message (OGM) which is played upon detection that the telephone number dialed from memory, “M1, M2 or M3” of control hub 12, has been answered. Specifically, when control hub 12 is activated, hub 12 dials the number stored in memory position M1. Control hub 12 detects that the telephone has been answered by a cessation in the telephone ringing the dialed number. Once a cessation in telephone ringing has been detected, the control hub begins to play the prerecorded message. The outgoing message can be up to 10 seconds in length and is recorded by the user speaking into microphone 43. The message is intended to inform the party answering the telephone that has been dialed from the memory of control hub 12 of the identity of the individual who is unable to personally telephone and other typical emergency information about the incapacitated individual. This information should include the address, other individuals to contract and/or the telephone numbers of the police and fire departments or ambulance service in the event these emergency services do not respond to recorded messages. The outgoing message is recorded onto an electrically erasable programmable read-only memory (EEPROM) to ensure that the outgoing message and emergency telephone numbers will not be lost if power to control hub 12 is interrupted.

The user may record the outgoing message by pressing the button marked “Rec OGM” 33 on keypad 24. The user presses the “Rec OGM” button 33 for three seconds after which a beep sounds, and the user may speak into microphone 43 to record the outgoing message. Once the user has completed the outgoing message, the user presses the “Rec OGM” button 33 for a second time to stop recording, at which point, the system will automatically play back the message that has been recorded. If the user wishes to play back the outgoing message at any time, the user depresses the button on keypad 24 marked “Playback OGM” 35. This will initiate playback of the outgoing message through the speaker 37 contained in control hub 12. If receiving a telephone call, the hub may be used as a speaker phone by depressing the button marked “Spkr” 39 on keypad 24 to allow use of the speaker phone feature of control hub 12. It will be appreciated that control hub 12 is equipped with a default outgoing message. Should the personally recorded outgoing message become deleted, or should the user not wish to personally record an outgoing message, the default outgoing message will be transmitted when control hub 12 is activated.

During operation of the safety alert system, the user will be able to activate control hub 12 from any location within 100 feet of control hub 12 by depressing activation 22 on pendant 14. The pendant 14 is intended to accompany the user to any location about the premises in which the safety alert system is installed. Upon depressing activation button 22, a radio frequency (rf) signal is transmitted from pendant 14 to control hub 12. Control hub 12 then becomes activated and begins dialing the first telephone number recorded at the “M1” memory location. If the control hub 12 does not receive a response to the first dialed number within one minute, the control hub will automatically disconnect that call and will dial the second telephone number recorded at the “M2” memory position. Control hub 12 will then allow that second dialed number to ring for up to one minute. If no answer is received at the phone recorded at the second memory position, the control hub will proceed to dial the telephone number contained on the third memory position “M3”.

In the event the dialed telephone number ceases to ring because the call is answered by an answering machine or facsimile machine or a non-responsive operator or the phone is busy or the other party picks up the phone and fails to properly respond, the control hub will detect this as a non-responsive dialing attempt. The control hub 12 then will proceed to dial the next number in memory in an attempt to receive a satisfactory response. A satisfactory response is generated by a human being answering the telephone call generated by the hub memory and responding to the recorded outgoing message which, in addition to providing information to the individual answering the phone, also requests that the individual press a particular number on the recipient keypad (such as # sign) in order to acknowledge receipt of the message. Alternatively, the recipient of the telephone call is instructed to press a different number (for example the *) if they understand that the message can be disregarded. In the event the control hub 12 does not receive a command from any of the telephone numbers called, the hub 12 then will try two more cycles for three attempts for each number and then cease dialing.

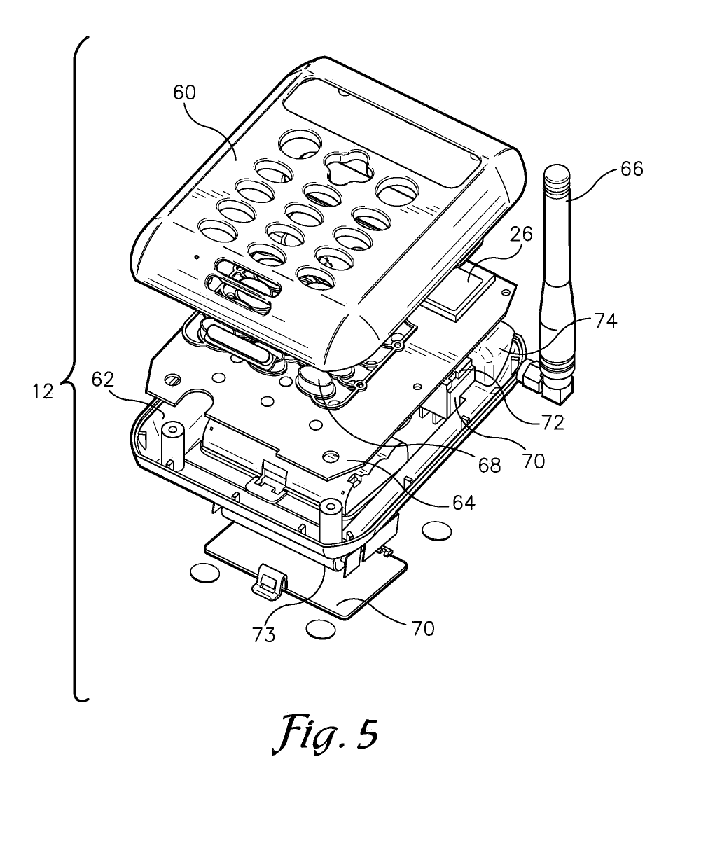

Referring now to FIG. 4, an exploded view of pendant 14 (FIG. 3) is shown. Pendant 14 is comprised of top housing 40 and bottom housing 46 which contain circuit board 44, battery or power source 48, activation LED 42, and rf transmitter 52 on circuit board 44. As previously described, activation button 22 is provided to activate rf transmitter 52 to thereby send a radio frequency signal to control hub 12 to activate the invention. Battery 48 is retained within housing 40, 46 by cap 50.

Referring now to FIG. 5, the components of control hub 12 will be described. Control hub 12 is comprised of front housing 60 and back housing 62 within which is contained circuit board 64 having display 26 and keypad buttons 68 thereon. The rf signal transmitted from pendant 14 is received by antenna 66 of control hub 12. Battery 73 is inserted into back housing 62 and retained therein by cover 70. A controller 70 also is provided on circuit board 64 with EEPROM 72. EEPROM 72 stores the outgoing message (OGM) and telephone numbers entered and saved by the user and controller 70 and its software operate the dialing and response monitoring functions previously described.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive safety alert system is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. A safety apparatus comprising:
a mobile radio frequency transmitter for user selectable transmission of a radio frequency signal therefrom to a receiver in a base unit to activate said base unit,
a controller in said base unit operating to initiate a sequential dialing of a series of user pre-selected and user pre-recorded telephone numbers upon said base unit receiver receiving said radio frequency signal from said mobile transmitter,
a memory for storing said series of user pre-selected and user pre-recorded telephone numbers and for storing a user pre-recorded message said message for playback to a recipient receiving a telephone call in response to said dialing of a series of user pre-selected and user pre-recorded telephone numbers by said controller, and
a human being response detection function in said controller to activate said controller for playback of said user pre-recorded message to a recipient of a telephone call initiated by said dialing of said dialing of a series of user pre-selected and user pre-recorded telephone numbers.

2. The method of telephonically notifying a telephone call recipient of a user's emergency by playback of a user pre-recorded message to at least one user pre-selected person comprising the steps of:
storing in a memory a plurality of user pre-selected telephone numbers,
recording in said memory a user pre-recorded message for playback to a telephone call recipient,
transmitting by a user a radio frequency signal from a mobile radio transmitter,
receiving said transmitted radio frequency signal at a base unit said base unit containing said memory and a controller activated by said received radio frequency signal for dialing sequentially said plurality of user pre-selected and user pre-recorded telephone numbers,
dialing sequentially said plurality of user pre-selected and user pre-recorded telephone numbers by said controller,
detecting by said controller a human response to at least one of said dialed plurality of user pre-selected and user pre-recorded telephone numbers, and
initiating playback from said memory of said user pre-recorded message upon said detecting a human response.
